(19) United States
(12) Patent Application Publication
(10) Pub. No.: US 2013/0192475 A1
(43) Pub. Date: Aug. 1, 2013

(54) Flat Flexible Cooker

(71) Applicants: Wayne Lee Lynn, Stoughton, WI (US); Judy Ann Lynn, Stoughton, WI (US)

(72) Inventors: Wayne Lee Lynn, Stoughton, WI (US); Judy Ann Lynn, Stoughton, WI (US)

(21) Appl. No.: 13/569,392

(22) Filed: Aug. 8, 2012

Related U.S. Application Data
(60) Provisional application No. 61/527,988, filed on Aug. 26, 2011.

(51) Int. Cl. A47J 37/06

(52) U.S. Cl. CPC A47J 37/06
USPC 99/444

(57) ABSTRACT

A user-friendly apparatus for the preparation of convenient frozen foods such as pizza, hot pockets, pre-breaded and deep fried foods. Apparatus is made of food grade heat conducting woven wire, varying in wire thickness and size. Apparatus size and thickness depends on customer preference and task. The woven wire will vary in openness from 65% to 70%. The woven wire will be a square or rectangular shape with all the edges folded twice. Where the corners meet, it is 6 wires thick. The corners are locks, which allow the woven wire to be flexed, stretched and twisted. This flexing allows for easy food release and the self-cleaning action of the woven wire. The folding of the edges and corners is what makes it possible for the woven wire to always be returned to its original shape. The openness of heat conducting woven wire allows the ambient and conductive heat to produce crisper food in less cooking and clean-up time.

### CROSS-REFERENCE TO RELATED

### Application

This application claims priority under 35 USC §119(e)U.S. Provisional Patent Application No. 61/527,988 filed Aug. 26, 2011, the entirety of which is incorporated by reference here in.

### FIELD OF THE INVENTION

This disclosure generally concerns an apparatus that simplifies the cooking of pizza and precooked frozen foods, specifically to an apparatus that cooks the foods more quickly without turning or scraping the foods off the pan and is easy to clean. These are the embodiments that the consumer most wants.

### BACKGROUND OF THE INVENTION

Pizza and other frozen foods go back a long way. There have always been problems with home preparation, food release, and clean-up. Most prior art is based on the effort to make home cooking better, while turning out foods that have all of the qualities the manufactures put into them. They do not address the whole process of preparation, cooking, food release, and clean-up. A novel apparatus would address these factors and even improve the quality of the food prepared.

Prior art consists of cookie sheets, perforated pans, and woven wire with ridged edges that are in 99/450, 426/496, 99/447 and other classes. Prior art concentrates only on the cooking and not the whole process. Consumers want one apparatus that will bake fast, uniformly without turning food over midway through the process, complete problem free food/debris release, crispy outside, moist inside, fast and healthy non greasy food with easy clean-up. This shows that there is a need for a new novel apparatus that can do it all.

Frozen foods often have debris and ice crystals in the package that come out with the product and make a mess on the baking apparatus. This makes cooking and clean-up more difficult.

Turning the food over midway through the cooking process is a most unpleasant task while using prior arts. First pulling out the oven rack with heat blasting you in the face, now hold the apparatus with a hot pad while turning over the food with as little damage to food and apparatus as possible. When food becomes damaged by turning and scraping from cooking apparatus, coatings, moisture and flavor are lost. This most unpleasant task is eliminated by the flat flexible cooker. The next unpleasant task is to remove the food from the apparatus after it is cooked without damaging food.

The goal of the invention is to satisfy the needs and wants of the customer. These embodiments are:

1. An easy way to eliminate ice crystals and debris from the cooking surface.

2. Foods baked evenly all around and top to bottom.

3. No turning over of food midway through baking so all sides cook evenly.

4. The deep fried breaded products are not baked in the oils that were frozen into the product; oils can fall away.

5. Healthy baking of foods by not cooking them in a puddle of oil.

6. Easy food release from baking apparatus.

7. Easy apparatus clean-up.

It is non-obvious in prior art attempts, that a flat flexible cooking surface is required to meet all of the customer needs and not just a few of them. There is a need for a novel apparatus that does meet the above seven goals in paragraph [007].

### A SUMMARY OF THE INVENTION

The invention of the Flat Flexible Cooker solves problems prior art has addressed but not solved. The driving force of the invention as defined in the claims of this disclosure is to solve problems like food stuck to the pan, turning food over midway through cooking without damage, getting food off of the cooking surface without damage, foods being cooked crispy just the way customers want, food cooked without added oil/grease, and easy fast clean-up. These problems are solved by the Flat Flexible Cookers' elements of construction that let debris fall away; heat circulates up, around, over and under food, and easy release of food from baking surface. Flexing, stretching and twisting the cooker moves the wires which releases food and debris so the apparatus is mostly self-cleaning and then easily returned to original shape.

### BRIEF DESCRIPTION OF DRAWINGS

FIG. 1 Reference 1 shows the double folded sides and the overlapping corners of the entire perimeter. Reference 2 illustrates the entire woven wire-cooking surface.

FIG. 2 Is a close up view of the bottom right corner of FIG. 1. Reference 3 is the right outer edge folded twice. Reference 4 is the bottom side folded twice. Reference 5 represents the corner where reference 3 and reference 4 overlapping folded edges that lock the corners, folds, and wire surface in place. Reference 6 shows the open space of the woven wire that lets airflow between wires and release of moisture.

FIG. 3 Reference 7 shows cheese runoff of a cooked pizza onto the cooking surface. Reference 8 shows pepperoni under the cooked cheese. Reference 9 shows the cooked surface of a cheese and pepperoni pizza sitting on top of the cooking surface. Reference 10 is the 2 folds of heat conducting wires around the cooker. Reference 11 points to the heat conducting surface.

FIG. 4 Reference 12 is a cheese and pepperoni pizza being removed from flexed cooking surface. Reference 13 shows the bits of cheese left on the cooking surface while the pizza is released onto a suitable cutting surface. Reference 14 shows how edges and cooking surface distorts while flexing, twisting and stretching the Flat Flexible Cooker.

FIG. 5 A close up view of the stretched wires of the cooker shown in FIG. 4. Reference 15 shows wires are curved from flexing and stretching, corners are locked.

FIG. 6 Shown in reference 16 is the Flat Flexible Cooker restored to the original shape after clearing debris and flexing.

FIG. 7 Shows cooking surface reference 17, with 8oz. of cheese burnt to a black as coal crisp reference 18.

FIG. 8 Flexed cooker reference 19, burnt cheese breaking into pieces reference 20.

FIG. 9 Cooker that has been stretched and flexed, reference 21, burnt cheese is breaking up and falling away from cooker.

FIG. 10 Cooker is clean of burnt on debris reference 22, reference 23 shows all of the debris have fallen off of the cooker.

FIG. 11 The cooking surface and edges have been returned to original shape, reference 24.

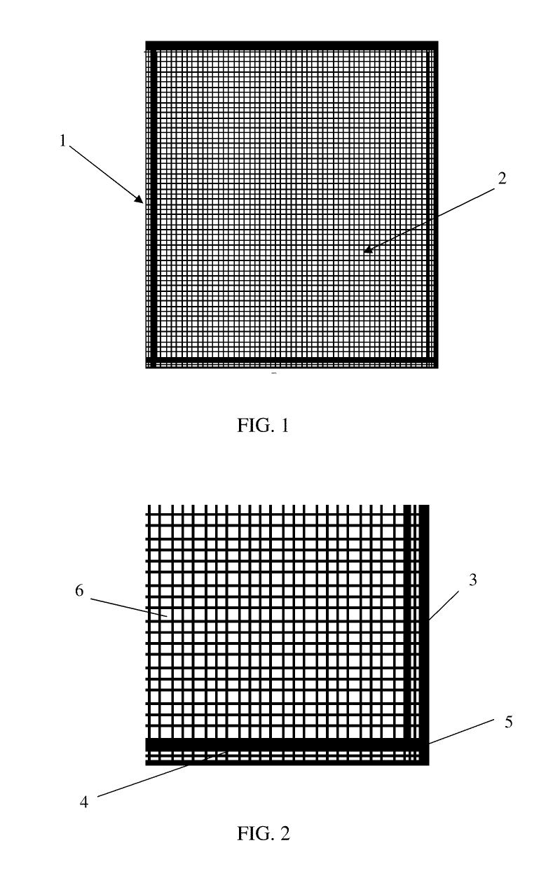

### DETAILED DESCRIPTION OF THE INVENTION

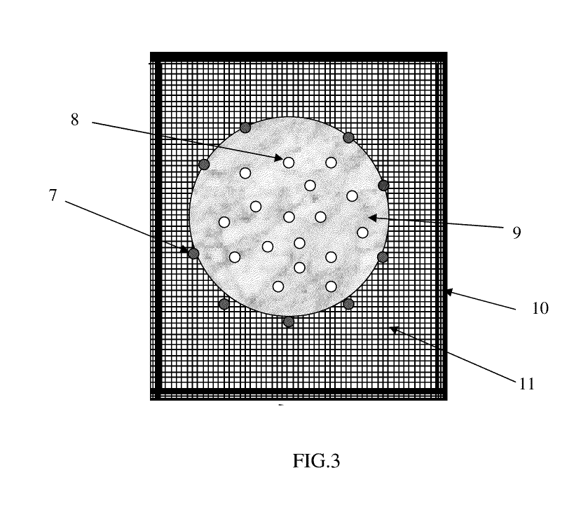

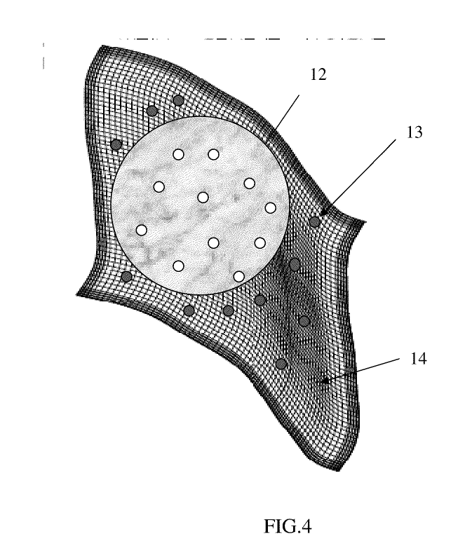

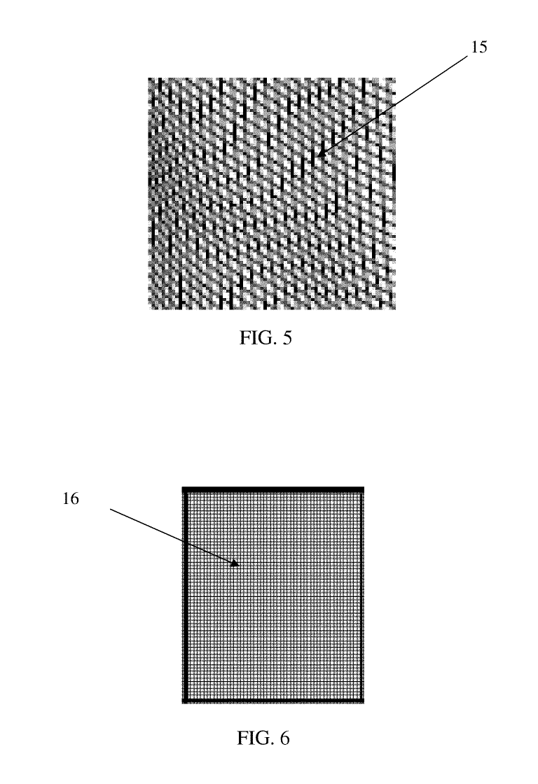

The Flat Flexible Cookers prototypes are made of food grade heat conducting woven metal wire 0.011 cm to 0.120 cm. Cut the wire 4″ larger than the finished product, the finished cooking surface needs to be at least 2″ larger than what is to be cooked. At least 1″ of space between the folded edge and the food is needed, for example a 12″ pizza should be cooked on a 14″ Flat Flexible Cooker so there is room for any pizza drippings and air flow, FIG. 3 reference 7, and the wires are allowed to conduct heat. A light duty 24″ table break can fold the wire. The first fold is ⅜″ then with a hand roller flatten the fold. The second fold is ⅝″ and then rolled flat. The wider top fold keeps the sharp ends of the bottom wire safe for use. The folded edge, reference 3 of FIG. 2, is now 3 wires thick. Now repeat on the remaining 3 sides. The 4 corners are 6 wires thick which locks the Flat Flexible Cooker in place, reference 4 of FIG. 2, while providing a totally flexible, stretchable and twistable product, FIG. 4, which can always be returned to the original shape, FIG. 5. Use only straight woven wire to enhance the easy food release and easy self-cleaning, FIG. 4 reference 13 and FIG. 6 reference 16. The thinner woven wire has the advantage of being an oven mess catcher and splatter guard. Thicker woven wire is better for heavier foods, like chicken and potatoes.

The Flat Flexible Cooker embodies all of the qualities that consumers want. The food is cooked on a 65-70% open surface, FIG. 2 reference 6. Ice crystals from frozen foods fall through the open spaces while preparing or evaporate during the cooking. The openness of the surface allows heat to come up through and circulate around the food.

The product sits on heat conducting woven wire, FIG. 3 reference 9. Woven, means one wire goes over then under the next wire, this results in half of the wires conducting heat to the food and the other half is gathering and transferring heat to remaining wires, this not only conducts heat to, but also all around the food, and reduces cooking time. FIG. 3 reference 10 indicates the outer folded edges of the cooking surface. This folded edge collects and transfers heat to FIG. 3 reference 11, which conducts heat under the pizza. Heat is magnified and transferred by wires, resulting in a faster more evenly cooked product.

The Flat Flexible Cooker works best when there is at least ¼″ space between items like hot-pockets, pieces of chicken, tater tots, and burritos. As the air circulates through the wire, under the foods and outer edges it allows the ambient and conductive heat to work cooperatively, producing evenly baked crisp foods.

Frozen food is heated on all sides equally, which means the food does not need to be turned or rotated. By pulling on opposing sides or corners of the Flat Flexible Cooker, food and debris are released, FIG. 4 reference 10 and 11. This is because the wires actually scrape each other clean, sort of like cleaning one knife with another knife. It is easiest for the baked on debris to be dry and hard for removal. This can be accomplished by just leaving the cooking surface in the oven until debris are hard, then take it and stretch so wires move and scrape against each other, this does the cleaning for you.

When the Flat Flexible Cooker is used for pizza; place the pizza on the wire with the folded wire edges down. This allows the pizza to slide right off after it is baked. Prior to baking the pizza can be doctored with extra toppings. Any topping that misses the pizza and is on the wires is not a problem to clean off after baking. Use a pizza paddle or cookie sheet to help transfer the Flat Flexible Cooker and pizza to and from the oven rack. Bake the pizza per manufactures directions but keep watch as the cooking time will be less. This is because the Flat Flexible Cooker allows more even heat to flow all around the pizza. When pizza is done and removed from oven, pull the corners and sides of the cooker to release the pizza from cooking surface then slide the pizza onto cutting board, cut pizza, put pizza back on cooking surface to keep crust from getting soggy while waiting to be eaten. The Flat Flexible Cooker works great for frozen foods in the same manner except the food goes on the cooker with the folded edges up to help prevent food like tater tots from sliding or rolling off.

Prepared frozen foods like chicken have excess oils trapped inside because of the manufacturing process that will drain away through the cooking surface. A drip catcher/pan can be put below on the bottom rack. The food will brown and get crispy all around, tastier, in less time and healthy.

The prior art or current methods available for consumers to use to prepare pizza and frozen foods at home consists of cookie sheets, perforated pans, woven wire with ridged edges, and the oven rack.

Frozen food baked on a cookie sheet needs to be turned over midway through baking in order to get all sides crisp, this turning over damages the breading. You can put oil or lightly grease the cookie sheet, which means you are adding calories and changing the taste of the food. Baked frozen food often needs to be scrapped off the sheet, damaging the food and the cookie sheet.

Perforated pans do a better job of heating all around the food but turning and scraping is needed to get the food released. Most come with instructions to lightly oil even if they are Teflon or PTFE coated. Teflon and PTFE coatings wear off, are damaged and can end up in the food.

Woven wire cookers with ridged edges do a fine job of baking pizza and frozen foods in a home oven. There is still the problem of food release and clean-up that is difficult because of the ridged edges, they do not flex. Food is damaged in the scrapping to release from wires. Debris that get stuck between the woven wires is difficult to clean because the wires do not clean themselves.

Self-raising crust manufacturer directions tell you to put the pizza straight from the freezer onto the oven rack. If the pizza is doctored by adding ingredients, these ingredients should be ready to apply as soon as the pizza is unwrapped and placed on the Flat Flexible cooker, add ingredients and then put into pre-heated oven.

It is non-obvious that the Flat Flexible Cooker can also be used as a splatter guard on pots and pans or a mess catcher under baked casseroles.

The folded woven wire provides a mostly open Flat Flexible Cooker is substantial enough to support food on the oven rack.

Placing food on the cooking surface prior to placing it in the oven will allow crumbs, ice, and debris to fall through or on top of the Flat Flexible Cooker will help keep the oven clean.

A smooth flat surface (pizza paddle, flat cookie sheet, etc.) will make it easy to place the Flat Flexible Cooker loaded with food on and off the oven rack without disturbing the position of the food.

Manufacturing the Flat Flexible Cooker out of different diameters of food grade heat conducting woven wire and in different widths, enables' the cooker to meet a variety of requirements for residential and commercial needs.

Fast cooling and freezing of factory breaded and deep fried foods traps oils inside that escape away when using the Flat Flexible Cooker from claim 1, they will be healthier, not soggy or oil soaked.

The use of heat conducting food grade woven wire allows the Flat Flexible Cooker to act as a dehydrator removing moisture when in an oven at a very low temperature.

It is non-obvious that the Flat Flexible Cooker is a unique kitchen tool that will get better as it darkens with use and age, because dark materials absorb heat better than shinny colored materials.

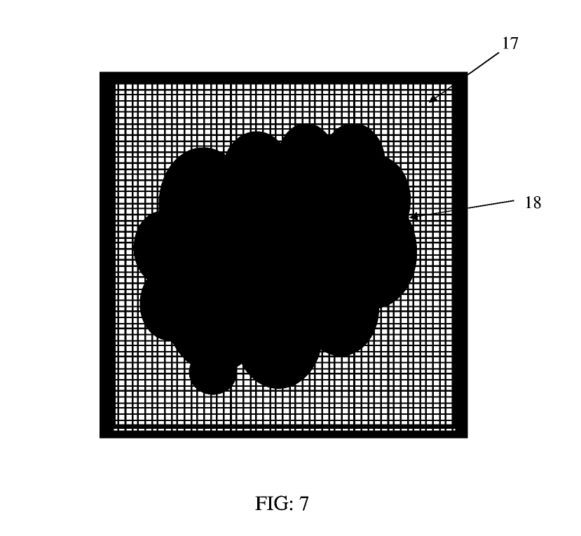

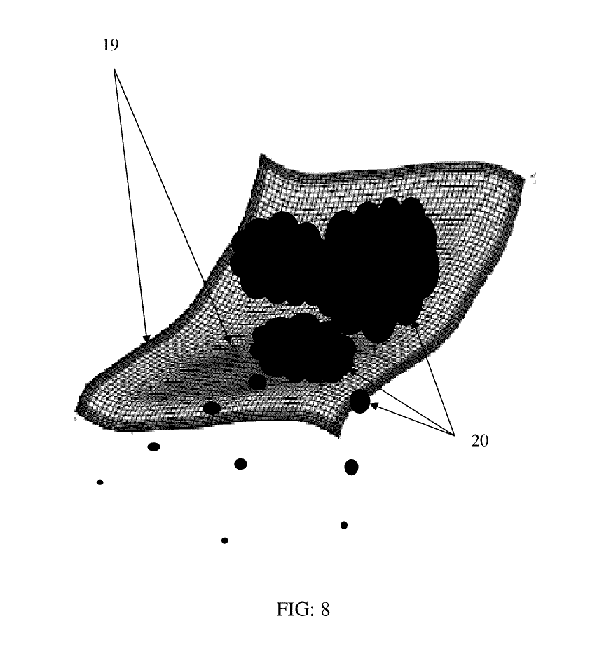

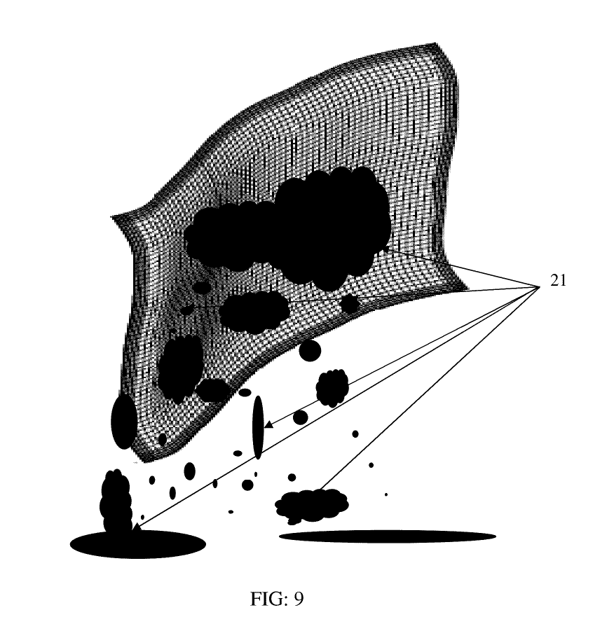

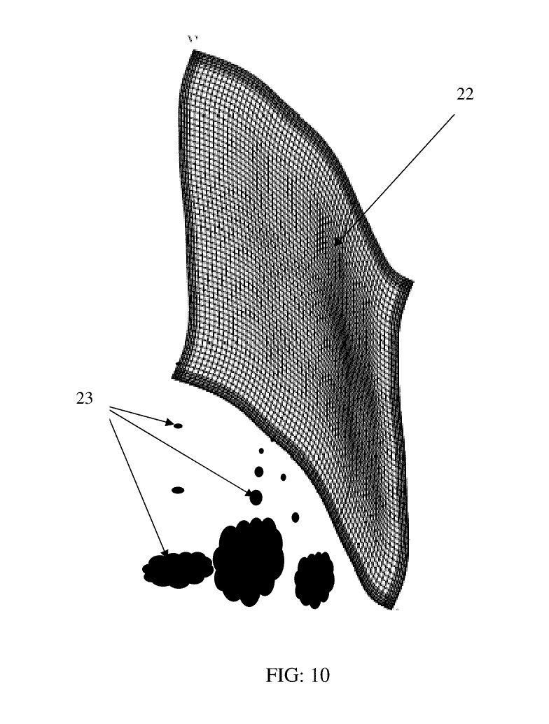

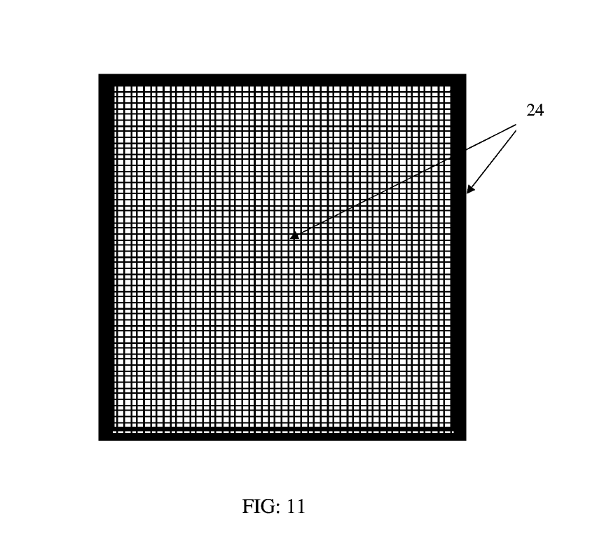

To show the non obvious preferred embodiments of self cleaning effectiveness of the Flat Flexible Cookers food release, 8 oz. of cheese was burned until it was brittle and black as coal FIG. 7, reference 18 shows the burned cheese FIG. 7, reference 17 points out the entire Flat Flexible Cooker surface. FIG. 8, reference 19 points out the entire cooker edge and surface in a flexed position that caused the burnt cheese (reference 20) to break away from the cooker surface. FIG. 9, reference 21 shows cutting action of wire against wire built into the cooker by the folding process when the cooker is flexed and stretched. In FIG. 10 the cooker reference 22, is now clean of debris which have fallen away reference 23. The process of cleaning the cooker of 8 oz. of burnt on cheese took less than 90 seconds. The cooker can now be flexed, stretched and twisted back to original shape as in FIG. 11 reference 24.

A driving force for this invention was to solve the problem of food release and self-cleaning. The double folded sides with three layers of wire resulting in locked corners six wires thick solves this problem, which is a preferred embodiment of the flat flexible cooker.

I/we claim as our invention:

1. The Flat Flexible Cooker is manufactured with food grade heat conducting straight woven wire 0.011 cm to 0.120 cm. thick, that is folded in a way such as to allow the whole novel apparatus to be flexed, stretched, and twisted for easy food release and returned to the original square or rectangle shape.

2. The apparatus in claim 1 can be made to almost any desired size by cutting the woven wire larger than the desired end dimensions.

3. In the apparatus of claim 1, each side of the pre cut woven wire is folded at least twice.

4. In the apparatus of claim 1, the first outside edge is folded over at least ¼″ smaller than the next fold, then rolled or pressed flat; then fold outside edge over again and roll or press flat; the four sides are now 3 wires thick, and the 4 corners are 6 wires thick.

5. The folded corners of the apparatus in claim 1 locks the sides and each wire in place while allowing the entire cooker to flex, stretch and twist.

6. The folding of the apparatus in claim 1 eliminates wire fatigue, while adding strength, and flexibility, and are the preferred elements of the Flat Flexible Cooker for a much longer life of use.

7. In the apparatus of claim 1, the food grade heat conducting woven wire has 65-70% open surface that allows ambient and conductive heat to work together and bake pre cooked frozen foods crispy and evenly in a shorter time.

8. Flexing, stretching and twisting the apparatus in claim 1, makes each straight woven wire move and scrape the other wires it touches resulting in easy food release and self cleaning.

9. The apparatus in claim 1 made with different diameters of food grade heat conducting woven wire cut in different widths, enables' the cooker to meet a variety of requirements for residential and commercial needs.

10. The preferred embodiments of the cooker in claim 1 has three wires thick for folded edges and six wires thick at the locking corners to solve the problem of food release and cleaning.

11. The woven wire in claim 1 has open spaces between the wires that allow ice crystals, debris, and oils that were frozen into the food to escape the food and cooker by falling through the cooker or evaporate away.

12. The heat conducting woven wire in claim 1 bakes food evenly all around, top and bottom so the food does not have to be rotated or turned over.

13. The apparatus in claim 1 will not allow food to be cooked in a puddle of oil as some prior art does and food will be healthier.

14. It is non-obvious that the properties of the folded woven wire in the apparatus of claim 1, will satisfy the preferred embodiments the customer wants in a cooker for frozen foods like fast and healthy, even all around cooking without turning, and easy food/debris clean-up.
